(19) United States
(12) Patent Application Publication
(10) Pub. No.: US 2026/0065459 A1
(43) Pub. Date: Mar. 5, 2026

(54) IMAGE FREEZING FOR PCB AND SEMICONDUCTOR INSPECTION

(71) Applicant: Orbotech Ltd., Yavne (IL)

(72) Inventors: Avraham Adler, Nof Ayalon (IL); Avinoam Rosenberg, Neria (Talmon) (IL); Mikhael Matusovsky, Rishon LeZion (IL); Avihay Hai Ankry, Rehovot (IL); Ronen Yogev, Yavne (IL)

(21) Appl. No.: 18/898,124

(22) Filed: Sep. 26, 2024

Related U.S. Application Data
(60) Provisional application No. 63/687,861, filed on Aug. 28, 2024.

(51) Int. Cl. G06T 7/00; G06V 10/141

(52) U.S. Cl. CPC G06T 7/0008; G06V 10/141; G06T 2207/30164

(57) ABSTRACT

The system includes a light source, a stage, a camera, and a mirror. The light source is configured to emit light. The stage is configured to support a workpiece and is movable to scan the light across the workpiece disposed on the stage. The camera is configured to receive reflected light from the workpiece and capture an image of the workpiece based on the reflected light received within an exposure time. The mirror is configured to direct the reflected light to the camera and rotate at a constant velocity that is synchronized with a velocity of the stage and the exposure time of the camera.

### CROSS-REFERENCE TO RELATED APPLICATIONS

This application claims priority to U.S. Provisional Application No. 63/687,861, filed Aug. 28, 2024, the entire disclosure of which is hereby incorporated by reference herein.

### FIELD OF THE DISCLOSURE

This disclosure relates to inspection systems and, more particularly, to inspection systems for detecting defects in semiconductor substrates or themselves.

### BACKGROUND OF THE DISCLOSURE

Evolution of the electronics manufacturing industry is placing greater demands on yield management and, in particular, on metrology and inspection systems. Critical dimensions continue to shrink, yet the industry needs to decrease time for achieving high-yield, high-value production. Minimizing the total time from detecting a yield problem to fixing it maximizes the return-on-investment for an electronics manufacturer.

Inspection processes are used at various steps during electronics manufacturing to detect defects on wafers, electronic devices, or electrical circuits to promote higher yield in the manufacturing process and, thus, higher profits. Inspection has always been an important part of fabricating electronic devices such as integrated circuits (ICs), flat panel displays (e.g., organic light emitting diode on silicon (OLEDoS) display panels), and printed circuit boards (PCBs), including assembled PCBs. However, as feature dimensions decrease, inspection becomes even more important to the successful manufacture of acceptable electronic devices because smaller defects can cause devices and assemblies to fail. For instance, as feature dimensions decrease, detection of defects of decreasing size has become necessary because even relatively small defects may cause unwanted aberrations in the devices.

Most optical inspection systems for PCB applications use linear sensors or TDI sensors when the light budget is not enough to reach the desirable signal level on the linear sensor. In some cases, an area sensor is preferable for uniform angular coverage illumination. Such inspection systems can operate in step and repeat mode, which allows enough light to get to the area sensor during frame exposure, but throughput is low due to constant jumping from one point to another and delays due to settling time. Another option is “on the fly” area scanning, which includes frame grabbing during movement of the tested object. To achieve high resolution for inspection, these systems may use strobe illumination. However, the strobing time is limited by the scanning velocity and the resolution. Therefore, a very high brightness is needed. Insufficient illumination can result in capture of blurred images or dark images.

Therefore, what is needed is an improved optical inspection for fast verification and detection of object defects with an area sensor and strobing illumination.

### BRIEF SUMMARY OF THE DISCLOSURE

An embodiment of the present disclosure provides a system. The system may comprise a light source configured to emit light; a stage configured to support a workpiece, wherein the stage is movable to scan the light across the workpiece disposed on the stage; a camera configured to receive reflected light from the workpiece and capture an image of the workpiece based on the reflected light received within an exposure time; and a mirror configured to direct the reflected light to the camera, wherein the mirror is configured to rotate at a constant velocity that is synchronized with a velocity of the stage and the exposure time of the camera.

In some embodiments, the light source may be configured to emit light according to a strobing frequency, the light may be configured to illuminate the workpiece for a duration of a pulse width of the strobing frequency, and the mirror may be configured to rotate at a constant velocity that is further synchronized with the duration of the pulse width of the light source.

In some embodiments, the camera may be configured to capture a plurality of images of the workpiece according to a frame rate, the frame rate may be synchronized with the strobing frequency, and the mirror may be configured to rotate at the constant velocity that is further synchronized with the frame rate of the camera.

In some embodiments, the system may further comprise a motor configured to rotate the mirror; and a processor in electronic communication with the motor. The processor may be configured to send a mirror signal to the motor to control rotation of the mirror, such that the mirror rotates at the constant velocity for the duration of the pulse width of the light source and the exposure time of the camera.

In some embodiments, the processor may be in electronic communication with the light source and the camera. The processor may be further configured to send a strobing signal to the light source to control the strobing frequency of the light source and send an exposure signal to the camera to control the exposure time and frame rate of the camera, such that the exposure time of the camera is encompassed by the duration of the pulse width of the light source.

In some embodiments, one period of the mirror signal may correspond to one period of the strobing signal and one period of the exposure signal.

In some embodiments, the light source may be a multi-modal light source configured to emit light of a first illumination modality for a first duration of the strobing signal and emit light of a second illumination modality for a second duration of the strobing signal, and the first illumination modality may be different from the second illumination modality.

In some embodiments, the exposure time of the camera may include a first exposure time encompassed by the first duration of the strobing signal and a second exposure time encompassed by the second duration of the strobing signal. The camera may be configured to capture a first image of the workpiece based on the reflected light received within the first exposure time and capture a second image of the workpiece based on the reflected light received within the second exposure time.

In some embodiments, one period of the mirror signal may encompass the first duration and the second duration of the strobing signal and the first exposure time and the second exposure time of the exposure signal.

In some embodiments, a first period of the mirror signal may encompass the first duration of the strobing signal and the first exposure time of the exposure signal, and a second period of the mirror signal may encompass the second duration of the strobing signal and the second exposure time of the exposure signal.

In some embodiments, the first duration and the second duration of the strobing signal may be unequal.

In some embodiments, the mirror may be configured to rotate at the constant velocity for the first duration and the second duration of the strobing signal.

In some embodiments, the stage may be movable in along a first axis, and the mirror may be configured to rotate along an axis orthogonal to the first axis.

In some embodiments, the system may further comprise an optical head configured to carry the light source, camera, and mirror. The stage may be movable along a first axis, and the optical head may be movable along a second axis that is orthogonal to the first axis.

In some embodiments, the mirror may be configured to rotate along an axis orthogonal to the second axis.

In some embodiments, the optical head may be movable along a third axis that is parallel to the first axis to move the camera to compensate for movement of the stage.

In some embodiments, the mirror may be a polygonal mirror.

Another embodiment of the present disclosure provides a method. The method may comprise: emitting light from a light source; moving a stage supporting a workpiece to scan the light across the workpiece; directing light reflected from the workpiece to a camera with a mirror; rotating the mirror in a first direction at a constant velocity that is synchronized with a velocity of the stage; and capturing an image of the workpiece with the camera based on the reflected light received by the camera within an exposure time. The mirror may be configured to rotate at the constant velocity for a duration of the exposure time of the camera.

In some embodiments, emitting light from the light source may comprise emitting light from the light source according to a strobing frequency. The light may illuminate the workpiece for a duration of a pulse width of the strobing frequency. The mirror may be further configured to rotate at the constant velocity for the duration of the pulse width of the light source.

In some embodiments, the light source may be a multi-modal light source. Emitting light from the light source may comprise emitting light of a first illumination modality for a first duration of the strobing frequency; and emitting light of a second illumination modality for a second duration of the strobing frequency, wherein the first illumination modality is different from the second illumination modality.

In some embodiments, the exposure time of the camera may include a first exposure time encompassed by the first duration of the strobing frequency and a second exposure time encompassed by the second duration of the strobing frequency. Capturing an image of the workpiece with the camera may comprise capturing a first image of the workpiece based on the reflected light received within the first exposure time; and capturing a second image of the workpiece based on the reflected light received within the second exposure time.

In some embodiments, the mirror may be configured to continuously rotate in the first direction at the constant velocity while the camera captures the first image of the workpiece and the second image of the workpiece.

In some embodiments, before emitting light of the second illumination modality and capturing the second image of the workpiece, the method may further comprise rotating the mirror in a second direction to a reset position, wherein the second direction is opposite to the first direction.

### DESCRIPTION OF THE DRAWINGS

For a fuller understanding of the nature and objects of the disclosure, reference should be made to the following detailed description taken in conjunction with the accompanying drawings, in which:

FIG. 1A is side view of a system according to an embodiment of the present disclosure;

FIG. 1B is a side of a planar mirror and motor of a system according to an embodiment of the present disclosure;

FIG. 2A is a side view of a system according to another embodiment of the present disclosure;

FIG. 2B is a side view of a polygonal mirror and motor of a system according to an embodiment of the present disclosure;

FIG. 3 is a signal graph illustrating mirror velocity, light strobing, and camera exposure of a system according to an embodiment of the present disclosure;

FIG. 4 is a signal graph illustrating mirror velocity, light strobing, and camera exposure of a system according to another embodiment of the present disclosure;

FIG. 5 is a signal graph illustrating mirror velocity, light strobing, and camera exposure of a system according to another embodiment of the present disclosure;

FIG. 6A is a top view of a system according to an embodiment of the present disclosure;

FIG. 6B is a top view of a system according to another embodiment of the present disclosure;

FIG. 7 is a side view of a system according to another embodiment of the present disclosure;

FIG. 8 is a flowchart of a method according to an embodiment of the present disclosure;

FIG. 9 is a flowchart of a method according to another embodiment of the present disclosure; and

FIG. 10 is a flowchart of a method according to another embodiment of the present disclosure.

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, process step, and electronic changes may be made without departing from the scope of the disclosure. Accordingly, the scope of the disclosure is defined only by reference to the appended claims.

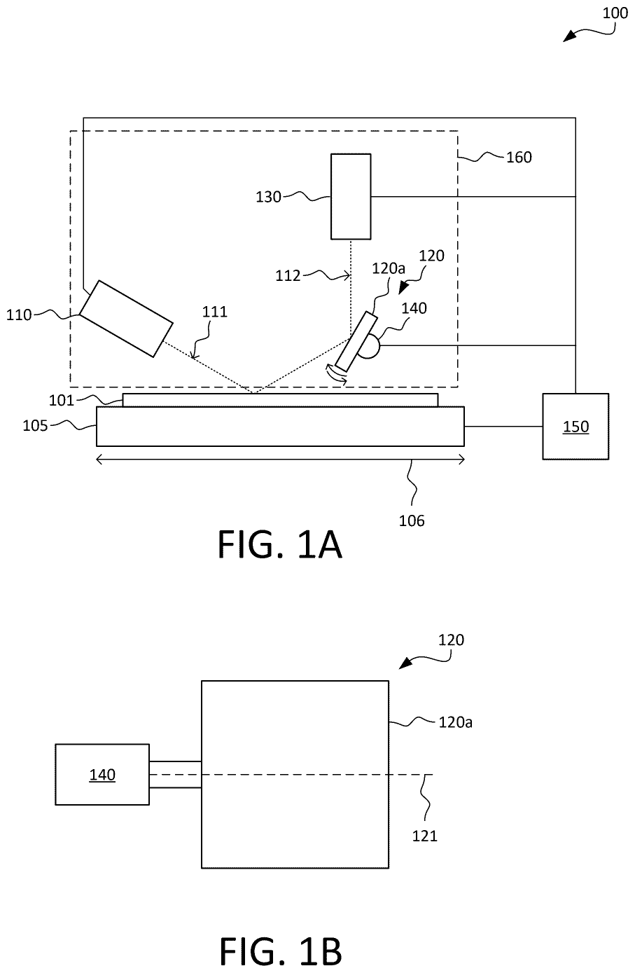

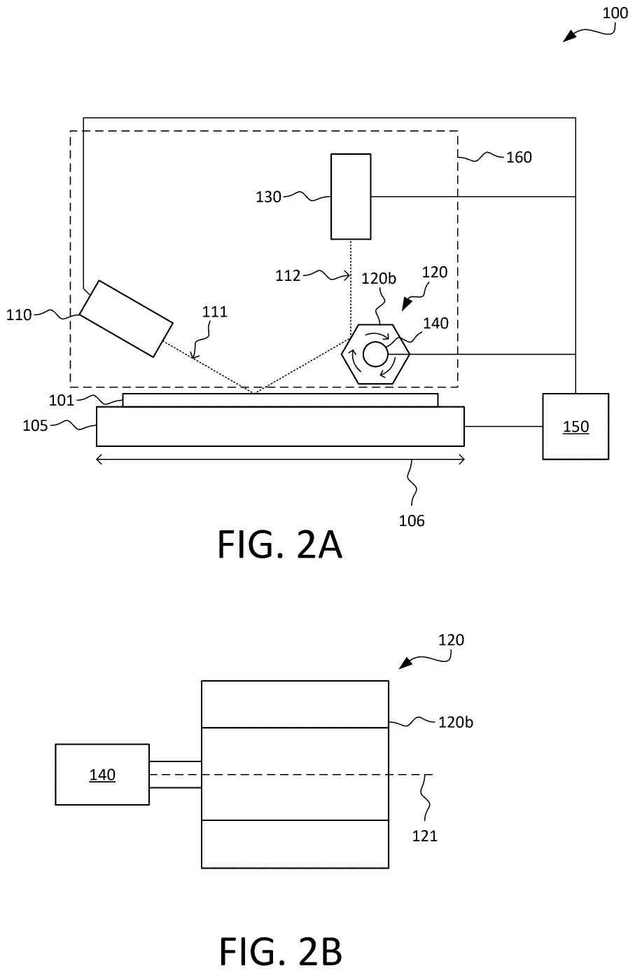

An embodiment of the present disclosure provides a system 100, as shown in FIG. 1A and FIG. 2A. The system 100 may be an inspection system configured to inspect a workpiece 101 to detect defects in the workpiece 101. The workpiece 101 may be a semiconductor wafer, substrate, printed circuit board (PCB), flat panel display (FPD), or other type of workpiece and is not limited herein.

The system 100 may comprise a light source 110. The light source 110 may be configured to emit light 111 according to a strobing frequency. The light 111 may be configured to illuminate the workpiece 101 for a duration of a pulse width of the strobing frequency. The duration of the pulse width may be, for example, 1 μs to 1 ms. The light 111 may be infrared light, visible light, or ultraviolet light. For example, the light 111 may have a wavelength in a range of 300 nm to 1000 nm. In some embodiments, the light source 110 may be configured to emit light 111 to produce static (continuous) illumination, without a strobing frequency. The light source 110 may be an LED or another type of light source.

The system 100 may further comprise a stage 105. The stage 105 may be configured to support the workpiece 101. The stage 105 may be movable to scan the light 111 across the workpiece 101. For example, the stage 105 may be configured to move with a velocity of 100 mm/sec to 10 m/sec. In an instance, the stage 105 may be configured to move with a velocity of 500 mm/sec. The stage 105 may be configured to move along a first axis 106.

The system 100 may further comprise a mirror 120 configured to direct reflected light 112 from the workpiece 101 to a camera 130. The mirror 120 may be a fast-steering mirror, a resonant mirror, or a galvo mirror. In some embodiments, the mirror 120 may be a planar mirror 120a (as shown in FIG. 1A and FIG. 1B) or a polygonal mirror 120b (as shown in FIG. 2A and FIG. 2B). In some embodiments, the mirror 120 may be disposed in the path of the reflected light 112 between the stage an objective lens (not shown). Alternatively, the mirror 120 may be disposed in the path of the reflected light 112 between the objective lens and the camera 130. The camera 130 may be configured to receive the reflected light 112 and generate one or more images of the workpiece 101 based on the reflected light 112 received within an exposure time of the camera 130. For example, the camera 130 may be specifically configured to generate one or more images of the workpiece 101 based on the type of the light 111 emitted by the light source 110 (e.g., infrared light, visible light, or ultraviolet light). In some embodiments, the camera 130 may move relative to the stage 105.

The system 100 may further comprise a motor 140. The motor 140 may be configured to rotate the mirror 120 at a constant velocity that is derived from a velocity of the stage 105. The timing and the duration of the constant velocity of the mirror 120 may be synchronized with the duration of the pulse width of the light source 110 and/or the exposure time of the camera 130. The specific structure of the motor 140 may depend on whether the mirror 120 is a fast-steering mirror, resonant mirror, galvo mirror, planar mirror 120a, polygonal mirror 120b, or other type of rotatable mirror assembly. As shown in FIG. 1B and FIG. 2B, the mirror 120 may be configured to rotate about a rotary axis 121. The rotary axis 121 may be orthogonal to the first axis 106. For a planar mirror 120a, the motor 140 may rotate the mirror 120 back and forth in opposite directions about the rotary axis 121. For a polygonal mirror 120b, the motor 140 may continuously rotate the mirror 120 about the rotary axis 121 in one direction. In either case, the rotation direction may depend on the scanning direction. If the rotary axis 121 is offset from the mirror surface (e.g., with the polygonal mirror 120b shown in FIG. 2A and FIG. 2B), the folding position where the reflected light 112 is reflected by the mirror 120 may vary depending on the rotational position of the mirror 120. Thus, the mirror 120 may be positioned such that the folding position is set where the change is significantly smaller than the degree of freedom or the mirror 120 can be placed where the reflected light 112 is collimated.

The system 100 may further comprise a processor 150. The processor 150 may include a microprocessor, a microcontroller, or other devices. The processor 150 may be coupled to the components of the system 100 in any suitable manner (e.g., via one or more transmission media, which may include wired and/or wireless transmission media) such that the processor 150 can receive output. The processor 150 may be configured to perform a number of functions using the output. An inspection tool can receive instructions or other information from the processor 150. The processor 150 optionally may be in electronic communication with another inspection tool, a metrology tool, a repair tool, or a review tool (not illustrated) to receive additional information or send instructions.

The processor 150 may be part of various systems, including a personal computer system, image computer, mainframe computer system, workstation, network appliance, internet appliance, or other device. The subsystem(s) or system(s) may also include any suitable processor known in the art, such as a parallel processor. In addition, the subsystem(s) or system(s) may include a platform with high-speed processing and software, either as a standalone or a networked tool.

The processor 150 may be disposed in or otherwise part of the system 100 or another device. In an example, the processor 150 may be part of a standalone control unit or in a centralized quality control unit. Multiple processors 150 may be used, defining multiple subsystems of the system 100.

The processor 150 may be implemented in practice by any combination of hardware, software, and firmware. Also, its functions as described herein may be performed by one unit, or divided up among different components, each of which may be implemented in turn by any combination of hardware, software and firmware. Program code or instructions for the processor 150 to implement various methods and functions may be stored in readable storage media, such as a memory.

If the system 100 includes more than one subsystem, then the different processors 150 may be coupled to each other such that images, data, information, instructions, etc. can be sent between the subsystems. For example, one subsystem may be coupled to additional subsystem(s) by any suitable transmission media, which may include any suitable wired and/or wireless transmission media known in the art. Two or more of such subsystems may also be effectively coupled by a shared computer-readable storage medium (not shown).

The processor 150 may be configured to perform a number of functions using the output of the system 100 or other output. For instance, the processor 150 may be configured to send the output to an electronic data storage unit or another storage medium. The processor 150 may be further configured as described herein.

The processor 150 may be configured according to any of the embodiments described herein. The processor 150 also may be configured to perform other functions or additional steps using the output of the system 100 or using images or data from other sources.

The processor 150 may be communicatively coupled to any of the various components or sub-systems of system 100 in any manner known in the art. Moreover, the processor 150 may be configured to receive and/or acquire data or information from other systems (e.g., inspection results from an inspection system such as a review tool, a remote database including design data and the like) by a transmission medium that may include wired and/or wireless portions. In this manner, the transmission medium may serve as a data link between the processor 150 and other subsystems of the system 100 or systems external to system 100. Various steps, functions, and/or operations of system 100 and the methods disclosed herein are carried out by one or more of the following: electronic circuits, logic gates, multiplexers, programmable logic devices, ASICs, analog or digital controls/switches, microcontrollers, or computing systems. Program instructions implementing methods such as those described herein may be transmitted over or stored on carrier medium. The carrier medium may include a storage medium such as a read-only memory, a random-access memory, a magnetic or optical disk, a non-volatile memory, a solid-state memory, a magnetic tape, and the like. A carrier medium may include a transmission medium such as a wire, cable, or wireless transmission link. For instance, the various steps described throughout the present disclosure may be carried out by a single processor 150 (or computer subsystem) or, alternatively, multiple processors 150 (or multiple computer subsystems). Moreover, different sub-systems of the system 100 may include one or more computing or logic systems. Therefore, the above description should not be interpreted as a limitation on the present disclosure but merely an illustration.

The processor 150 may be in electronic communication with the stage 105. For example, the processor 150 may be configured to send instructions to one or more motors or actuators of the stage 105 to move the stage 105 along the first axis 106.

The processor 150 may be in electronic communication with the motor 140. For example, the processor 150 may be configured to send a mirror signal 125 to the motor 140 to control rotation of the mirror 120, such that the mirror 120 rotates at a constant velocity for the duration of the pulse width of the light source 110 and the exposure time of the camera 130.

The processor 150 may be in electronic communication with the light source 110 and the camera 130. For example, the processor 150 may be configured to send a strobing signal 115 to the light source 110 to control the strobing frequency of the light source 110 and send an exposure signal 135 to the camera 130 to control the exposure time and frame rate of the camera 130. The processor 150 may synchronize the strobing signal 115 and the exposure signal 135 such that the exposure time of the camera 130 is encompassed by the duration of the pulse width of the strobing frequency of the light source 110. In some embodiments, the processor 150 may synchronize one of the strobing signal 115 or the exposure signal 135 with the mirror signal 125. For example, for a light source 110 configured to produce static illumination, the processor 150 may synchronize the exposure signal 135 with the mirror signal 125.

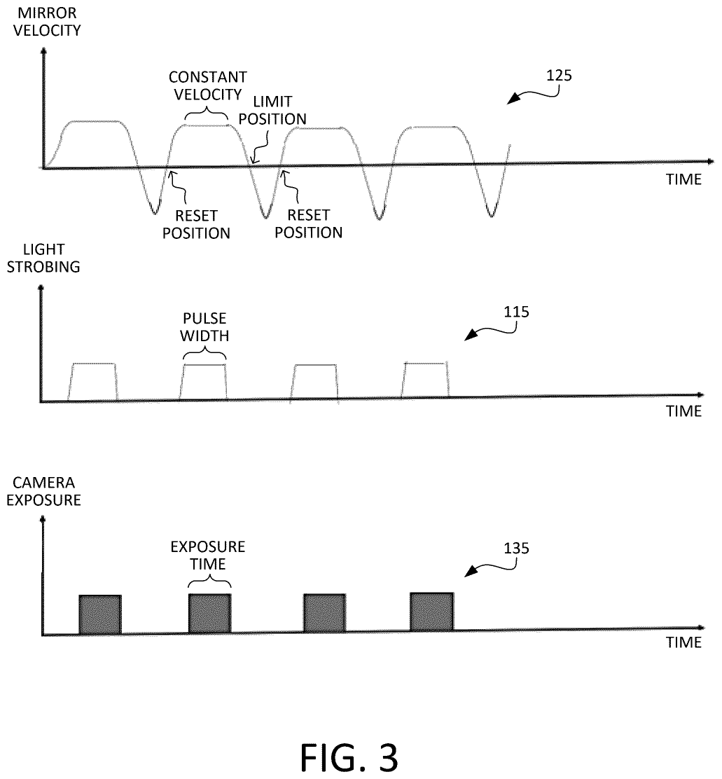

FIG. 3 illustrates graphs of the mirror signal 125, strobing signal 115, and exposure signal 135 according to an embodiment of the present disclosure. As can be seen, the mirror signal 125 applied to the motor 140 controls the mirror 120 to rotate at a constant velocity for a duration that is synchronized with the pulse width of the strobing frequency controlled by the strobing signal 115 and the exposure time of the camera 130 controlled by the exposure signal 135. Accordingly, the resolution of the one or more images captured by the camera 130 can be improved based on the increased exposure time and pulse width without blurring.

In an instance, the mirror 120 may have a maximum constant velocity of 20 rad/sec, which can provide a constant velocity of about 200 microseconds for a mirror signal 125 having a frequency of 1000 Hz (i.e., a period of 1000 microseconds). Based on the angular range of motion of the mirror 120, the mirror 120 may be configured to rotate back and forth according to the mirror signal 125. For example, the mirror signal 125 applied to the motor 140 may be configured to rotate the mirror 120 in a first direction and then rotate the mirror in a second direction, opposite to the first direction. In other words, the mirror 120 may rotate in the first direction until it has reached a limit position of its angular range of motion, and then may rotate back in the second direction to a reset position. As shown in FIG. 3, the rotation in the first direction is shown as the positive velocity portion of the mirror signal 125 between the reset position and the limit position, and the rotation in the second direction is shown as the negative velocity portion of the mirror signal 125 between the limit position and the reset position. In the illustrated example, the mirror 120 is configured to rotate in the first direction at the constant velocity.

A period of the mirror signal 125 may be defined by the time between rotations reaching the reset position of the mirror 120. In the embodiment shown in FIG. 3, one period of the mirror signal 125 corresponds to one period of the strobing signal 115 and one period of the exposure signal 135. In other words, for each pulse of light 111 of the light source 110, the mirror 120 may complete one rotation (from the reset position to the limit position and back) and the camera 130 may capture an image of the workpiece 101 within the exposure time. In some embodiments, the period of the mirror signal 125 may be 1 to 2 milliseconds, such that the process can be repeated to scan across the workpiece 101 and capture several corresponding images.

In some embodiments, the light source 110 may be a multi-modal light source. For example, the light source 110 may be configured to emit light according to different illumination modalities at separate times. The different illumination modalities may have different wavebands producing different types of light (e.g., infrared light, visible light (RGB), ultraviolet light, etc.). For example, the light source 110 may be configured to emit light of a first illumination modality and a second illumination modality. In some embodiments, the light source 110 may be configured to emit light of more than two illumination modalities, or the system 100 may include multiple light sources 110 configured to emit light of two or more illumination modalities. The processor 150 may apply a strobing signal 115 to the light source 110 to alternate pulses of light with the first illumination modality and the second illumination modality. For example, the strobing signal 115 may control the light source 110 to emit light of the first illumination modality for a first duration of the strobing frequency and emit light of the second illumination modality for a second duration of the strobing frequency.

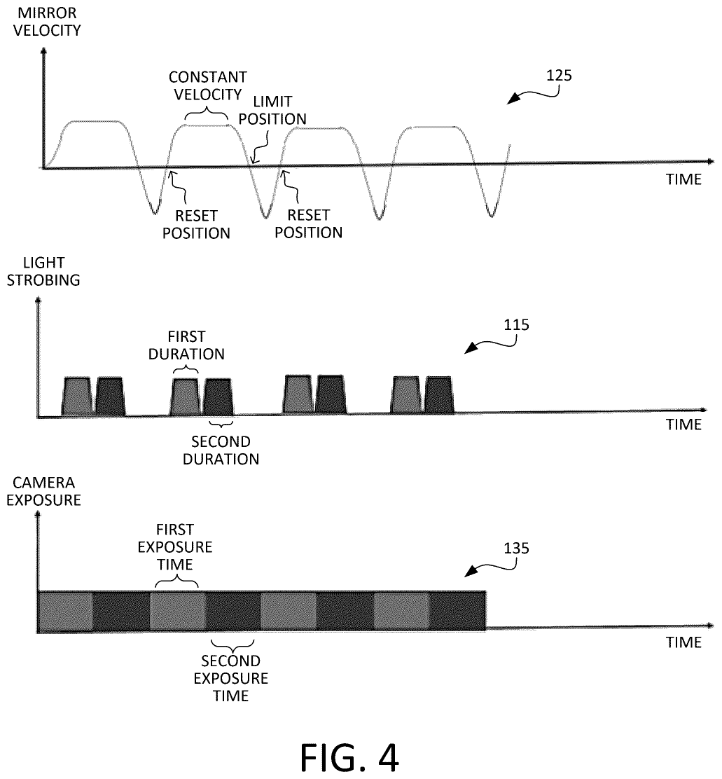

In some embodiments, the camera 130 may be configured to generate one or more images of the workpiece 101 according to each illumination modality of the light source, and the processor 150 may apply an exposure signal to the camera 130 to capture an image with each illumination modality. For example, the exposure signal 135 may control the camera 130 to capture a first image of the workpiece 101 based on the reflected light received within a first exposure time and capture a second image of the workpiece 101 based on the reflected light within a second exposure time. As shown in FIG. 4, the first exposure time may be encompassed by the first duration of the strobing signal 115 and the second exposure time may be encompassed by the second duration of the strobing signal 115.

In some embodiments, one period of the mirror signal 125 may encompass the first duration and the second duration of the strobing signal 115 and the first exposure time and the second exposure time of the exposure signal 135. For example, as shown in FIG. 4, the light source 110 is configured to emit two pulses of light (i.e., one with each illumination modality) and the camera is configured to capture two images (i.e., one with each illumination modality) during the duration of constant velocity rotation of the mirror 120. In other words, the mirror 120 is configured to rotate at the constant velocity for the first duration and the second duration of the strobing signal and the first exposure time and the second exposure time of the exposure signal, such that the resolution of the first image and the second image captured by the camera 130 can be improved based on the increased exposure time without blurring. With the frequency of the mirror signal 125 being half of the exposure signal 135, the gap between the light pulses of the strobing signal 115 can be minimized within the constant velocity duration of the mirror signal 125, and the exposure signal 135 can be aligned such that first exposure time ends immediately after the first light pulse and the second exposure time begins immediately with the second light pulse.

In some embodiments, the first duration and the second duration of the strobing signal may be equal. For example, the light source 110 may be configured to emit light of the first illumination modality and emit light of the second illumination modality for equal durations of time. Consequently, the first exposure time and the second exposure time of the exposure signal may also be equal durations of time encompassed by the first duration and the second duration, respectively. Alternatively, the first duration and the second duration of the strobing signal may be unequal. For example, for some illumination modalities, the camera 130 may use a longer or shorter exposure time to capture images at the respective illumination modalities. For example, bright field illumination may have a short exposure time and/or pulse time, while dark field illumination may have long exposure time and/or pulse time. In addition, a combination of fluorescence imaging and reflective imaging may use different exposure times. Accordingly, the strobing signal 115 may set the first duration and the second duration with appropriate times for sufficient illumination of the workpiece 101 with each illumination modality, and the exposure signal may define the first exposure time and the second exposure time to be encompassed by the first duration and the second duration, respectively.

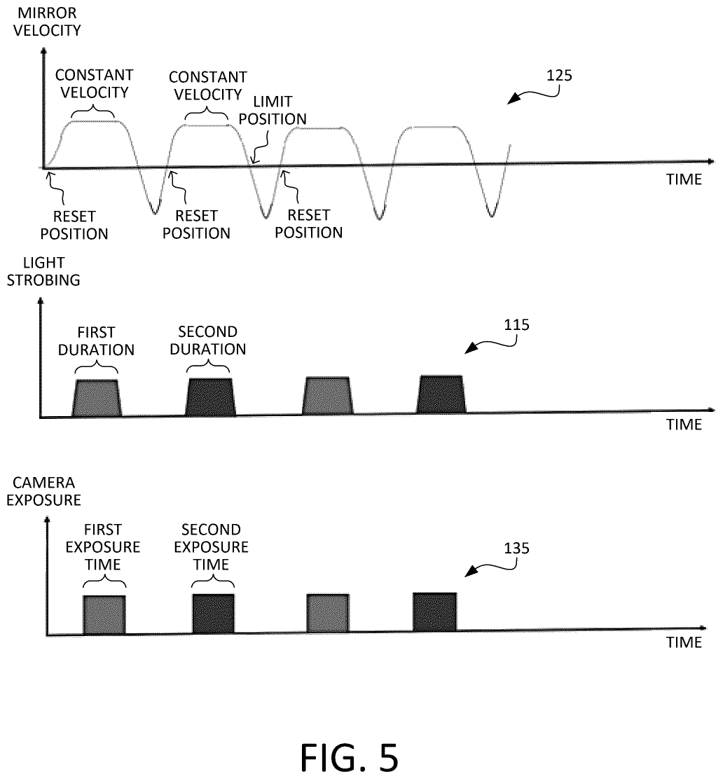

In some embodiments, a first period of the mirror signal 125 encompasses the first duration of the strobing signal 115 and the first exposure time of the exposure signal 135, while a second period of the mirror signal 125 encompasses the second duration of the strobing signal 115 and the second exposure time of the exposure signal 135. As illustrated in FIG. 5, the mirror 120 may complete one rotation (from the reset position to the limit position and back) for the first duration of the first illumination modality and first exposure time so that the camera 130 can capture the first image of the workpiece 101, and then the mirror 120 can complete a second rotation for the second duration of the second illumination modality and second exposure time so that the camera 130 can capture the second image of the workpiece 101. Accordingly, the first exposure time and the second exposure time can be maximized for the duration of constant velocity of the mirror 120, such that the resolution of the first image and the second image captured by the camera 130 can be improved based on the increased exposure time without blurring.

The mirror signal 125 and the strobing signal 115 may be selected to maximize the exposure signal 135 according to the frame rate of the camera 130. The choice may depend on the characteristics of the components of the system 100 and the characteristics of the images captured by the camera 130. For example, a mirror signal 125 in accordance with the embodiment shown in FIG. 4 may use a mirror 120 with a low reset rate but a high angular range, while a mirror signal 125 in accordance with the embodiment shown in FIG. 5 may use a mirror 120 with a high reset rate but a small angular range.

While FIG. 3-5 illustrate a strobing signal 115 applied to a light source 110 to produce pulsed light, other signals can be used to applied to the light source 110 to produce continuous light and light of different illumination modalities, which could be synchronized with the mirror signal 125 and the exposure signal 135 in a similar fashion.

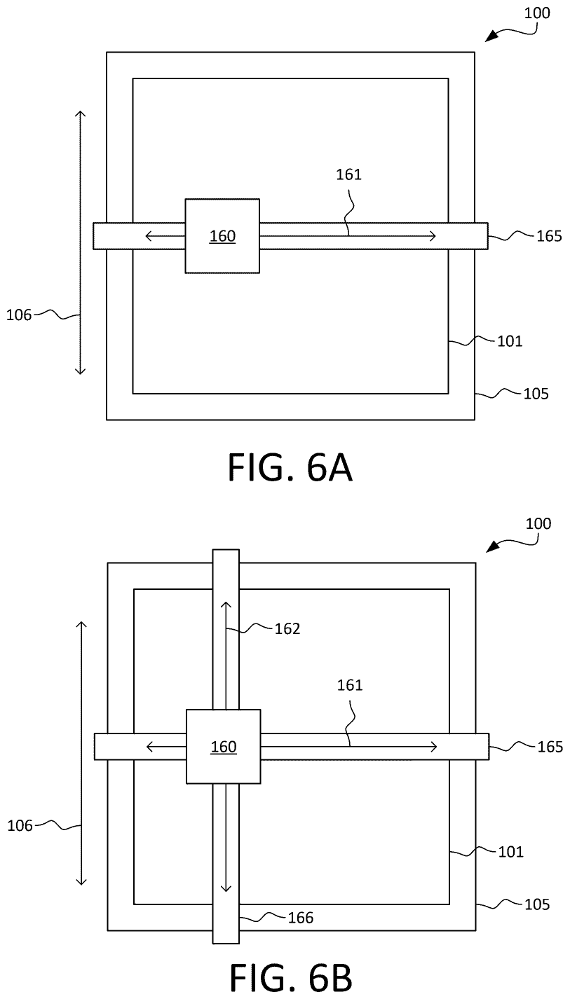

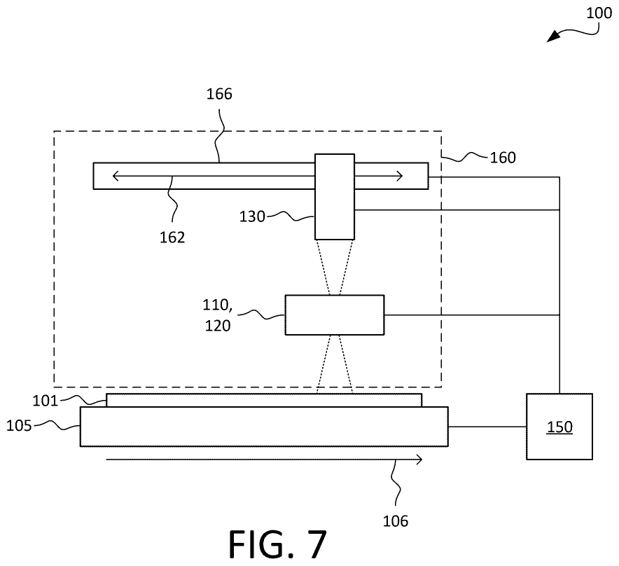

The system 100 may further comprise an optical head 160. The optical head 160 may be configured to carry one or more of the light source 110, the mirror 120, and the camera 130. In some embodiments, the optical head 160 may be movable along a second axis 161, as shown in FIG. 6A. For example, the optical head 160 may include one or more actuators that are configured to move the optical head 160 along the second axis. In some embodiments, the system 100 may further include a first bridge 165, and the one or more actuators may be configured to move the optical head 160 along the second axis 161 via the first bridge 165. The processor 150 may be configured to send instructions to the one or more actuators of the optical head 160 to move the optical head 160 along the second axis 161 via the first bridge 165. The second axis 161 may be orthogonal to the first axis 106. In other words, the stage 105 and the optical head 160 may be configured to move in two orthogonal directions, such that the system 100 can be configured to inspect the two-dimensional surface area of the workpiece 101.

In some embodiments, the optical head may be movable along the second axis 161 and a third axis 162, as shown in FIG. 6B. In some embodiments, the system 100 may further include a second bridge 166, and the one or more actuators may be configured to move the optical head 160 along the third axis 162 via the second bridge 166. The processor 150 may be configured to send instructions to the one or more actuators of the optical head 160 to move the optical head 160 along the second axis 161 via the first bridge 165 and along the third axis 162 via the second bridge 166. The third axis 162 may be parallel to the first axis 106 of the stage 105.

In some embodiments, the rotary axis 121 of the mirror 120 may be orthogonal to the second axis 161 instead of being orthogonal to the first axis 106. In other words, the mirror 120 may be configured to rotate at a constant velocity that is synchronized with a velocity of the optical head 160 for the duration of the pulse width of the light source 110 and the exposure time of the camera 130. Alternatively, the mirror 120 may be configured to rotate along two rotary axes, one of which is orthogonal to the first axis and another which is orthogonal to the second axis, with a motor 140 configured to drive each rotary axis. For example, the mirror 120 may be provided with a two-axis gimbal configured to rotate along the two rotary axes with one or more motors 140.

Accordingly, the mirror 120 may be configured to rotate at a constant velocity that is synchronized with both the velocity of the stage 105 and the velocity of the optical head 160, depending on which one (or both) of the stage 105 or the optical head 160 is moving during inspection.

With the system 100, the mirror 120 rotates at a constant velocity that is synchronized with the velocity of the stage 105 for a duration of the pulse width of the light source 110 and the exposure time of the camera 130, such that blurring of images captured by the camera 130 can be reduced. For example, the mirror 120 can compensate for the workpiece 101 moving during the strobing of the light from the light source 110, by freezing the image on camera 130, so the strobing time could be significantly increased without blurring increase. The synchronization with the velocity of the stage 105 can be achieved with a planar mirror 120a or a polygonal mirror 120b, of which a polygonal mirror 120b can reduce the rotation velocity for synchronization in a continuous rotational direction compared to a planar mirror 120a that rotates back and forth in two directions. Accordingly, the system 100 can produce video on the fly with a continuous scanning motion rather than a step and repeat motion, which increases process throughput. Therefore, the system 100 can be used for optical inspection with fast verification and detection of defects in the workpiece 101.

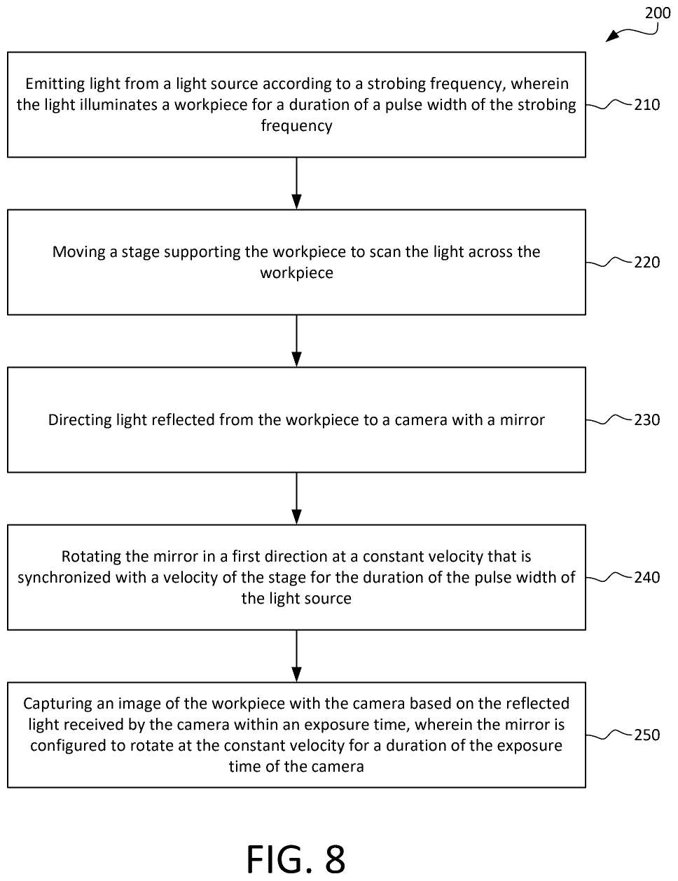

Another embodiment of the present disclosure provides a method 200. At shown in FIG. 8, the method 200 may comprise the following steps.

At step 210, light is emitted from a light source according to a strobing frequency. The light is configured to illuminate a workpiece for a duration of a pulse width of the strobing frequency. In some embodiments, the light source may be a static light source, and thus step 210 may comprise emitting light from the light source for continuous illumination.

At step 220, a stage supporting the workpiece is moved to scan the light across the workpiece.

At step 230, a mirror directs light reflected from the workpiece to a camera.

At step 240, the mirror is rotated in a first direction at a constant velocity that is synchronized with a velocity of the stage for a duration of an exposure time of the camera. In some embodiments, the mirror may be rotated in the first direction at the constant velocity that is further synchronized with the velocity of the stage for the duration of the pulse width of the light source.

At step 250, the camera captures an image of the workpiece based on the reflected light received by the camera within the exposure time.

In some embodiments, the method 200 may be repeated every 1 to 2 milliseconds to scan across the workpiece and capture several corresponding images.

In some embodiments, the light source may be a multi-modal light source.

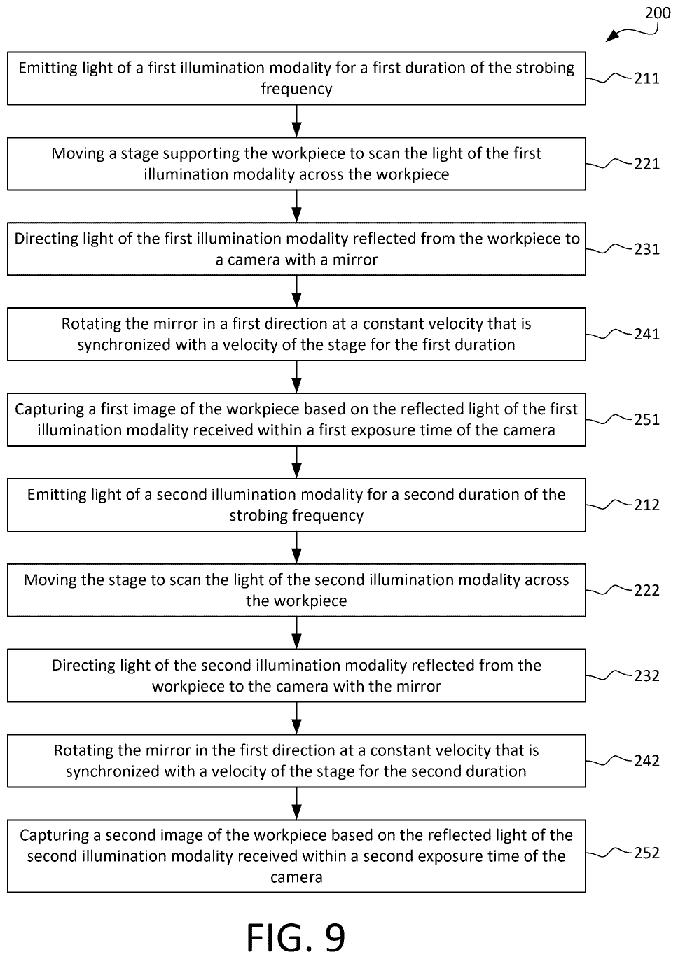

Accordingly, the method 200 may comprise the following alternative steps shown in FIG. 9.

At step 211, light of a first illumination modality is emitted for a first duration of the strobing frequency.

At step 221, a stage supporting the workpiece is moved to scan the light of the first illumination modality across the workpiece.

At step 231, a mirror directs light of the first illumination modality reflected from the workpiece to a camera.

At step 241, the mirror is rotated in a first direction at a constant velocity that is synchronized with a velocity of the stage for the first duration of the pulse width of the light source and a first exposure time of the camera.

At step 251, a first image of the workpiece is captured based on the reflected light received by the camera within the first exposure time.

At step 212, light of a second illumination modality is emitted for a second duration of the strobing frequency. The second illumination modality may be different from the first illumination modality.

At step 222, the stage is moved to scan the light of the second illumination modality across the workpiece.

At step 232, the mirror directs light of the second illumination modality reflected from the workpiece to the camera.

At step 242, the mirror is rotated in the first direction at a constant velocity that is synchronized with the velocity of the stage for the second duration of the pulse width of the light source and a second exposure time of the camera.

At step 252, a second image of the workpiece is captured based on the reflected light of the second illumination modality received by the camera within the second exposure time.

In some embodiments, the method 200 may comprise additional steps to illuminate the workpiece with light of additional illumination modalities and capture images of the workpiece corresponding to each of the different illumination modalities of the multi-modal light source.

In some embodiments, the mirror may be configured to continuously rotate in the first direction at the constant velocity while the camera captures the first image of the workpiece and the second image of the workpiece. In other words, for each rotational period of the mirror, the camera may capture two images of the workpiece having different illumination modalities. In some embodiments, the first duration and the second duration may be unequal. For example, based on the different illumination modalities, a greater amount of light received by the camera within an exposure time may increase the resolution of the image. Accordingly, the first duration and the second duration may be selected so as to allocate time based on improved resolution of images captured in each illumination modality.

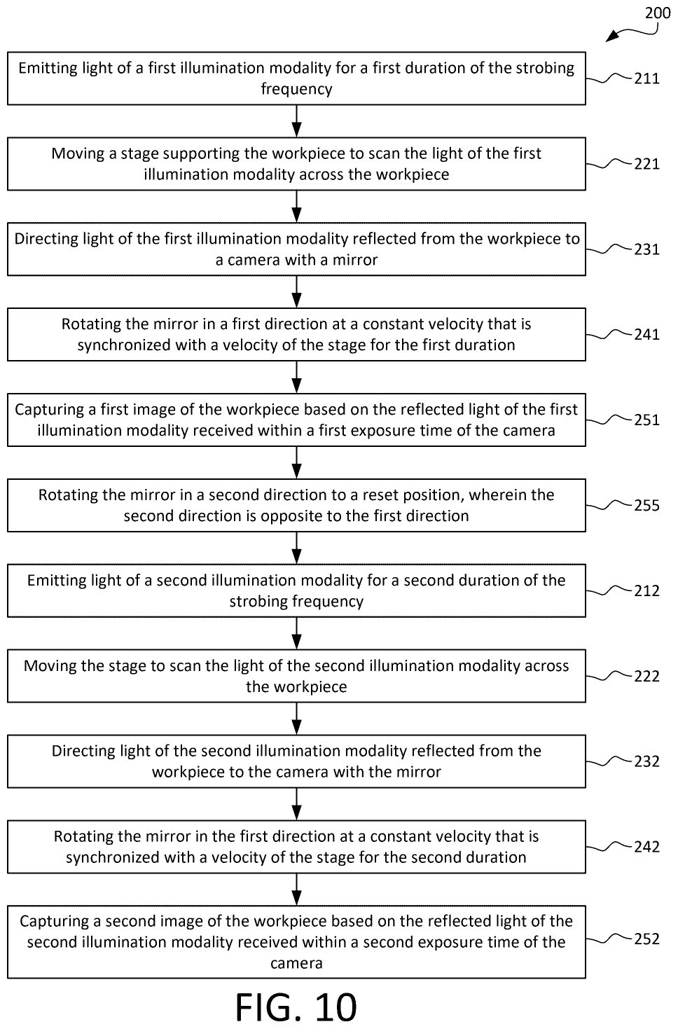

In some embodiments, the mirror may be configured to complete one rotational period for each illumination modality. For example, before step 212, the method may further comprise step 255 shown in FIG. 10. At step 255, the mirror is rotated in a second direction to a reset position. The second direction may be opposite to the first direction. In other words, after step 251, the mirror may be rotated to in the first direction to a limit position, and in step 255, the mirror is rotated back to in the second direction to the reset position. Accordingly, the mirror may rotate back in the first direction at the constant velocity while the light source illuminates the light of the second illumination modality in step 212 and the camera captures the second image of the workpiece in step 252. By providing one rotational period for each illumination modality, the amount of light received by the camera while the mirror is rotated at a constant velocity that is synchronized with the velocity of the stage can be maximized, which can improve image resolution. In some embodiments, step 255 may be repeated after step 252 to allow the camera to capture additional images of the workpiece according to additional illumination modalities.

With the method 200, the mirror rotates at a constant velocity that is synchronized with the velocity of the stage for a duration of the pulse width of the light source and the exposure time of the camera, such that blurring of images captured by the camera can be reduced. For example, the mirror can compensate for the object moving during the strobing, by freezing the image on area sensor, so the strobing time could be significantly increased without blurring increase. The synchronization with the velocity of the stage can be achieved with a planar mirror or a polygonal mirror, of which a polygonal mirror can reduce the rotation velocity for synchronization in a continuous rotational direction compared to a planar mirror that rotates back and forth in two directions. Accordingly, the method 200 can produce video on the fly with a continuous scanning motion rather than a step and repeat motion, which increases process throughput. Therefore, the method 200 can be used for optical inspection with fast verification and detection of defects in the workpiece.

Although the present disclosure has been described with respect to one or more particular embodiments, it will be understood that other embodiments of the present disclosure may be made without departing from the scope of the present disclosure. Hence, the present disclosure is deemed limited only by the appended claims and the reasonable interpretation thereof.

What is claimed is:

1. A system comprising:
a light source configured to emit light;
a stage configured to support a workpiece, wherein the stage is movable to scan the light across the workpiece disposed on the stage;
a camera configured to receive reflected light from the workpiece and capture an image of the workpiece based on the reflected light received within an exposure time; and
a mirror configured to direct the reflected light to the camera, wherein the mirror is configured to rotate at a constant velocity that is synchronized with a velocity of the stage and the exposure time of the camera.

2. The system of claim 1, wherein the light source is configured to emit light according to a strobing frequency, the light is configured to illuminate the workpiece for a duration of a pulse width of the strobing frequency, and the mirror is configured to rotate at a constant velocity that is further synchronized with the duration of the pulse width of the light source.

3. The system of claim 2, wherein the camera is configured to capture a plurality of images of the workpiece according to a frame rate, the frame rate is synchronized with the strobing frequency, and the mirror is configured to rotate at the constant velocity that is further synchronized with the frame rate of the camera.

4. The system of claim 2, further comprising:
a motor configured to rotate the mirror; and
a processor in electronic communication with the motor, wherein the processor is configured to send a mirror signal to the motor to control rotation of the mirror, such that the mirror rotates at the constant velocity for the duration of the pulse width of the light source and the exposure time of the camera.

5. The system of claim 4, wherein the processor is in electronic communication with the light source and the camera, and the processor is further configured to send a strobing signal to the light source to control the strobing frequency of the light source and send an exposure signal to the camera to control the exposure time and frame rate of the camera, such that the exposure time of the camera is encompassed by the duration of the pulse width of the light source.

6. The system of claim 5, wherein one period of the mirror signal corresponds to one period of the strobing signal and one period of the exposure signal.

7. The system of claim 5, wherein the light source is a multi-modal light source configured to emit light of a first illumination modality for a first duration of the strobing signal and emit light of a second illumination modality for a second duration of the strobing signal, and the first illumination modality is different from the second illumination modality.

8. The system of claim 7, wherein the exposure time of the camera includes a first exposure time encompassed by the first duration of the strobing signal and a second exposure time encompassed by the second duration of the strobing signal, and the camera is configured to capture a first image of the workpiece based on the reflected light received within the first exposure time and capture a second image of the workpiece based on the reflected light received within the second exposure time.

9. The system of claim 8, wherein one period of the mirror signal encompasses the first duration and the second duration of the strobing signal and the first exposure time and the second exposure time of the exposure signal.

10. The system of claim 8, wherein a first period of the mirror signal encompasses the first duration of the strobing signal and the first exposure time of the exposure signal, and a second period of the mirror signal encompasses the second duration of the strobing signal and the second exposure time of the exposure signal.

11. The system of claim 7, wherein the first duration and the second duration of the strobing signal are unequal.

12. The system of claim 7, wherein the mirror is configured to rotate at the constant velocity for the first duration and the second duration of the strobing signal.

13. The system of claim 1, wherein the stage is movable in along a first axis, and the mirror is configured to rotate along an axis orthogonal to the first axis.

14. The system of claim 1, further comprising an optical head configured to carry the light source, the camera, and the mirror, wherein the stage is movable along a first axis and the optical head is movable along a second axis that is orthogonal to the first axis.

15. The system of claim 14, wherein the mirror is configured to rotate along an axis orthogonal to the second axis.

16. The system of claim 14, wherein the optical head is movable along a third axis that is parallel to the first axis to move the camera to compensate for movement of the stage.

17. The system of claim 1, wherein the mirror is a polygonal mirror.

18. A method comprising:
emitting light from a light source;
moving a stage supporting a workpiece to scan the light across the workpiece;
directing light reflected from the workpiece to a camera with a mirror;
rotating the mirror in a first direction at a constant velocity that is synchronized with a velocity of the stage; and
capturing an image of the workpiece with the camera based on the reflected light received by the camera within an exposure time, wherein the mirror is configured to rotate at the constant velocity for a duration of the exposure time of the camera.

19. The method of claim 18, wherein emitting light from the light source comprises:
emitting light from the light source according to a strobing frequency, wherein the light illuminates the workpiece for a duration of a pulse width of the strobing frequency;
wherein the mirror is further configured to rotate at the constant velocity for the duration of the pulse width of the light source.

20. The method of claim 19, wherein the light source is a multi-modal light source, and emitting light from the light source comprises:
emitting light of a first illumination modality for a first duration of the strobing frequency; and
emitting light of a second illumination modality for a second duration of the strobing frequency, wherein the first illumination modality is different from the second illumination modality.

21. The method of claim 20, wherein the exposure time of the camera includes a first exposure time encompassed by the first duration of the strobing frequency and a second exposure time encompassed by the second duration of the strobing frequency, and capturing an image of the workpiece with the camera comprises:
capturing a first image of the workpiece based on the reflected light received within the first exposure time; and
capturing a second image of the workpiece based on the reflected light received within the second exposure time.

22. The method of claim 21, wherein the mirror is configured to continuously rotate in the first direction at the constant velocity while the camera captures the first image of the workpiece and the second image of the workpiece.

23. The method of claim 21, wherein before emitting light of the second illumination modality and capturing the second image of the workpiece, the method further comprises:
rotating the mirror in a second direction to a reset position, wherein the second direction is opposite to the first direction.
